(19) United States
(12) Patent Application Publication
(10) Pub. No.: US 2010/0159875 A1
(43) Pub. Date: Jun. 24, 2010

(54) Telephone Handset Contact List Synchronization

(75) Inventor: Gregory H. Bellows, Austin, TX (US)

Correspondence Address: IBM Corporation (PEC);c/o Patrick E. Caldwell, Esq., The Caldwell Firm, LLC, PO Box 59655, DALLAS, TX, 75229-0655, US

(73) Assignee: INTERNATIONAL BUSINESS MACHINES CORPORATION, Armonk, NY (US)

(21) Appl. No.: 12/338,935

(22) Filed: Dec. 18, 2008

(51) Int. Cl. H04M 1/66; H04M 3/00

(52) U.S. Cl. 455/410; 455/418

(57) ABSTRACT

A method comprises a first telephone handset selecting a second telephone handset as an approved contact exchange partner. The first telephone handset and the second telephone handset comprise contact information organized in a database. The first telephone handset establishes a telephone call between the first telephone handset and the second telephone handset. The first telephone handset receives contact update information from the second telephone handset in a first protocol. The first telephone handset synchronizes the contact update information with the contact information of the first telephone handset.

### TECHNICAL FIELD

The present invention relates generally to the field of information management and computer networking and, more particularly, to a system and method for improved telephone handset contact list synchronization.

### BACKGROUND

Modern electronic telephone systems are in widespread use. Many people own multiple telephone devices, including land based and cellular telephones. The handsets for each of these phones sometimes contain an electronic database configured to contain personal contact information, also known as an “address book.”

For example, many telephone handsets can save user-provided information as a “contact,” with data fields for a name, address, telephone number, etc. Some telephone handsets can also store captured caller identification (ID) information as a contact entry. Most systems allow a user to edit, delete, and otherwise manage the entries in a handset's address book.

In both cases, however, the typical address book is physically restricted to the handset itself. If the user wishes to retrieve information from the address book, the user must be physically present at the handset to retrieve the information. In some cases, a software system allows a user to download the address book to a computer, and to synchronize the address book with the computer copy. But in both cases, the user must be physically present at the computer or the handset to retrieve the information.

As such, if a cellular telephone user wishes to access an address book entry on a land-based telephone handset, the user must have the land-based handset physically present. Moreover, multiple address books lead to confusion over which information is correct, and leave information gaps. A user may want information found in the other address book, but not have the other handset physically present.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

A method comprises a first telephone handset selecting a second telephone handset as an approved contact exchange partner. The first telephone handset and the second telephone handset comprise contact information organized in a database. The first telephone handset establishes a telephone call between the first telephone handset and the second telephone handset. The first telephone handset receives contact update information from the second telephone handset in a first protocol. The first telephone handset synchronizes the contact update information with the contact information of the first telephone handset.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram showing a telephone handset contact list synchronization system in accordance with a preferred embodiment;

FIG. 2 illustrates a block diagram showing a telephone handset contact list synchronization system in accordance with a preferred embodiment;

FIG. 3 a high-level flow diagram depicting logical operational steps of an improved telephone handset contact list synchronization method, which can be implemented in accordance with a preferred embodiment; and

FIG. 4 illustrates an example computer system that can be configured in accordance with a preferred embodiment.

### DETAILED DESCRIPTION

The particular values and configurations discussed in these non-limiting examples can be varied and are cited merely to illustrate at least one embodiment and are not intended to limit the scope of the invention.

In the following discussion, numerous specific details are set forth to provide a thorough understanding of the present invention. Those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, user interface or input/output techniques, and the like, have been omitted inasmuch as such details are not considered necessary to obtain a complete understanding of the present invention, and are considered to be within the understanding of persons of ordinary skill in the relevant art.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

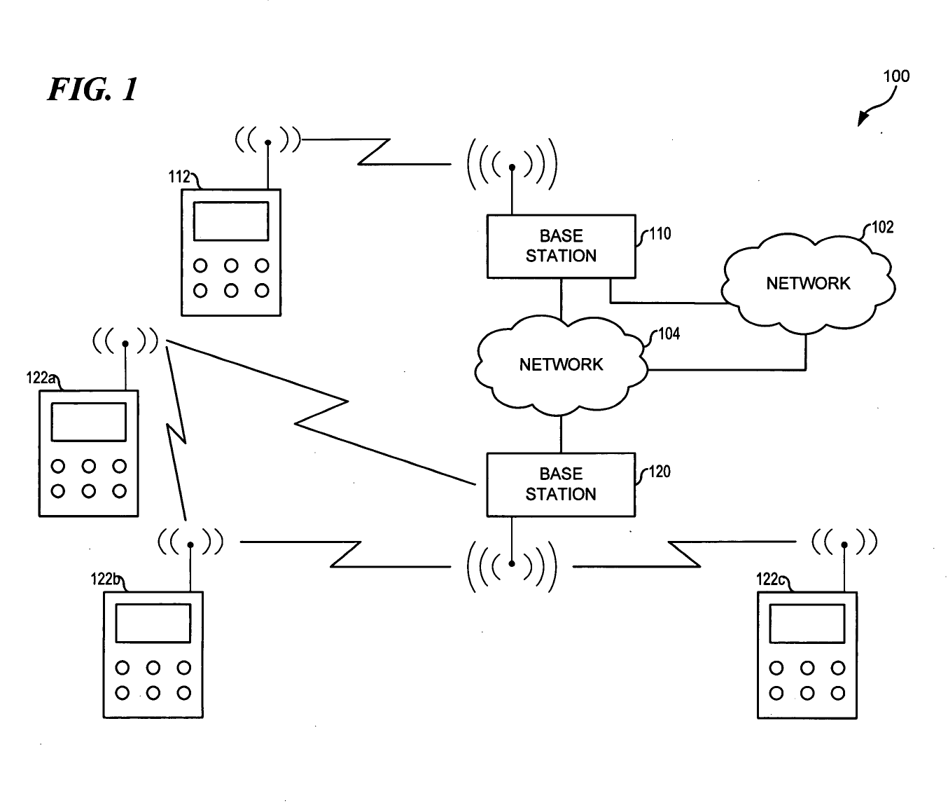

Referring now to the drawings, FIG. 1 is a high-level block diagram illustrating certain components of a system 100 for improved telephone handset contact list synchronization, in accordance with a preferred embodiment. System 100 includes a “plain old telephone service” (POTS) network 102 coupled to a network 104. Generally, POTS network 102 is an otherwise conventional public switched telephone network (PSTN) and network 104 is an otherwise conventional network, which in one embodiment includes some PSTN elements.

In the illustrated embodiment, a base station 110 couples to POTS network 102. In the illustrated embodiment, base station 110 is an otherwise conventional home telephone cordless base station, modified as described herein. As illustrated, base station also couples to network 104. In an alternate embodiment, base station 102 couples only to the POTS network 102. In the illustrated embodiment, base station 110 couples to a cordless telephone handset 112. Handset 112 is an otherwise conventional cordless telephone handset, modified as described herein.

In the illustrated embodiment, a base station 120 couples to network 14. In the illustrated embodiment, base station 120 is an otherwise conventional cellular telephone tower. In the illustrated embodiment, a plurality of cellular telephone handsets 122 couple to each other and to base station 120. Generally, handsets 122 are otherwise conventional cellular telephone handsets, modified as described herein.

In operation, as described in more detail below, a human user makes and receives telephone calls from handset 112 to other telephone handsets 112 over the POTS network 102, or to handsets 122 over the network 104. In addition to standard telephone calls, handset 112 and one or more handsets 122 are also configured to synchronize contact information.

Specifically, the embodiments described herein allow contact data synchronization via regular telephone channels using a standard modem/fax type protocol. As such, system 100 supports remote update and synchronization without requiring close physical proximity of the remote handset. In one embodiment, a user operating handset 122c, for example, can synchronize the contact information of handset 122c with the contact information on the user's home telephone handset 112, from a remote location. As such, system 100 allows someone away from home to fetch contact list information from their home phone (handset 112) by initiating a call from their remote cell phone (handset 122c).

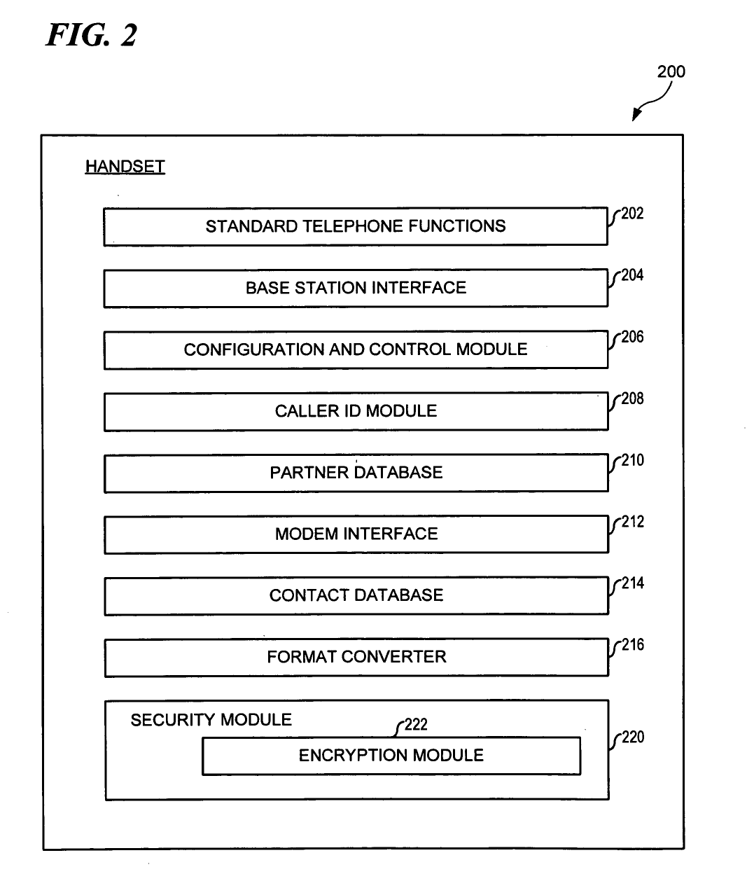

FIG. 2 is a high-level block diagram illustrating certain components of a system 200 for improved telephone handset contact list synchronization, in accordance with a preferred embodiment. System 200 includes a handset 201.

Handset 201 includes standard telephone functions module 202, which performs standard telephone functions such as dialing and establishing a connection with a telephone communication system. Handset 201 also includes base station interface 204, which serves as an interface between handset 201 and a communications base station. For example, where handset 201 is a cellular telephone, base station interface 204 is configured to provide an interface with a conventional cellular telephone tower. Where handset 201 is a home cordless telephone, base station interface 204 is configured to provide an interface with a conventional cordless telephone base station.

Handset 201 also includes a configuration and control (C&C) module 206, which is configured to provide a user interface to modify variables of handset 201. For example, where handset 201 is a cellular telephone, C&C module 206 provides an interface for a user to change a ring tone and other options of handset 201. In one embodiment, C&C module 206 also provides a user interface for a user to enter and/or modify contact information in a contact database, described below.

Handset 201 also includes a caller ID module 208. Caller ID module 208 is an otherwise conventional caller ID module, configured to receive and process caller identification (ID) information, as described in more detail below. Handset 201 also includes a partner database 210. Generally, partner database 210 is an otherwise conventional database, configured to store information identifying one or more approved contact information exchange partners. Generally, as used herein, an “approved contact information exchange partner” is a handset that is approved (by a user) for contact information synchronization with handset 201. In one embodiment, handset 201 identifies approved contact information exchange partners by the telephone number assigned to the remote handset.

Handset 201 also includes a modem interface 212. In one embodiment, modem interface 212 is an otherwise conventional facsimile (fax) modem. In an alternate embodiment, modem interface 212 is an otherwise conventional communications modem. In an alternate embodiment, modem interface 212 is configured to serve as an interface between handset 201 and a conventional fax modem or communications modem on a base station (not shown).

Handset 201 also includes contact database 214. Contact database 214 is an otherwise conventional database, configured to store contact information. Generally, as used herein “contact information” includes at least a name and associated telephone number. In one embodiment, contact information includes one or more of the following: name, address, primary telephone number, alternate telephone numbers, birthday, anniversary, notes, electronic mail addresses, title, employer, or other suitable information.

Generally, contact database 214 organizes contact information in a particular format. For example, in one embodiment, contact database 214 organizes the contact information by telephone number and provides a field for an associated name. In an alternate embodiment, contact database 214 also provides a field for an associated address. In an alternate embodiment, contact database 214 organizes the contact information by name and provides a field for an associated telephone number.

Accordingly, handset 201 also includes format converter 216. Generally, format converter 216 is configured to receive contact information in one format, and to return the received contact information in another format. For example, in one embodiment, format converter 216 receives contact information in a {number, name} format, and returns the received contact information in a {name, number} format. In an alternate embodiment, format converter 216 receives contact information in a {name, number, address} format and returns the received contact information in a {name, number} format, truncating the individual records.

In one embodiment, format converter 216 converts between formats based on input received by format converter 216. In an alternate embodiment, format converter 216 is configured to identify the format of received contact information and to convert the received contact information into a predetermined format.

Handset 201 also includes security module 220. Generally, security module 220 is an otherwise conventional telephone handset security module, modified as described below. In the illustrated embodiment, security module 220 includes encryption module 222. Encryption module 222 is an otherwise conventional encryption module configured to encrypt and decrypt contact information for transmission between handsets.

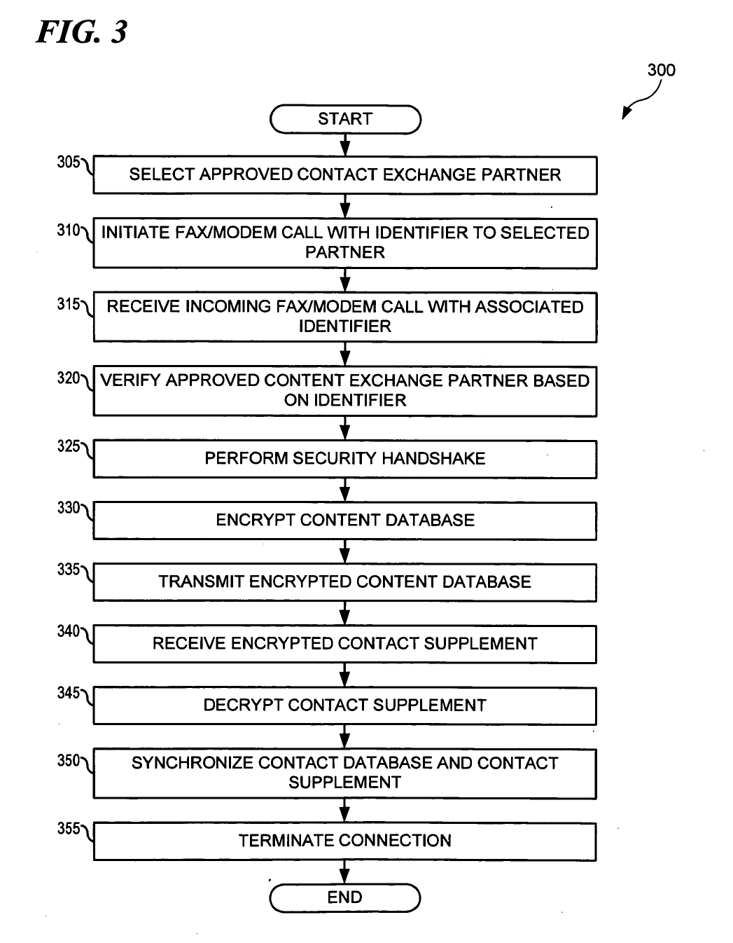

Generally, in one embodiment, handset 201 operates as described with reference to FIG. 3. FIG. 3 illustrates one embodiment of a method for improved telephone handset contact information synchronization. Specifically, FIG. 3 illustrates a high-level flow chart 300 that depicts logical operational steps performed by, for example, handset 201 of FIG. 2, which may be implemented in accordance with a preferred embodiment. Generally, handset 201 performs the steps of the method, unless indicated otherwise.

As indicated at block 305, the process begins, wherein handset 201 selects an approved contact exchange partner. For example, a user operating handset 201 selects an approved contact exchange partner from the partners stored in partner database 210. In an alternate embodiment, a user operating handset 201 enters and selects a new approved contact exchange partner from the partners stored in partner database 210.

Next, as illustrated at block 310, handset 201 initiates a fax or modem call with the selected partner. For example, modem 212 initiates a fax or modem call with the selected partner. In one embodiment, handset 201 includes an identifier identifying handset 201 to the selected partner. In one embodiment, the identifier comprises conventional caller ID information. In an alternate embodiment, the identifier comprises an operator indicating to the selected partner that handset 201 is initiating a contact synchronization call.

Alternatively, as illustrated at block 315, handset 201 receives an incoming fax or modem call, including an associated identifier. For example, standard telephone functions module 202 detects an incoming telephone call and connect, and modem interface 212 identifies the incoming call as a fax/modem call, accepting the fax/modem call. In an embodiment where handset 201 initiates the call, handset 201 receives an identifier from the selected partner.

Next, as illustrated at block 320, handset 201 verifies the approved content exchange partner based on the received identifier. For example, caller ID module 208 receives the selected partner's caller ID information and security module 220 compares the received information with the list of approved partners in partner database 210.

Next, as illustrated at block 325, handset 201 performs a conventional security handshake with the selected partner. For example, security module 220 establishes and performs a security handshake with the selected partner. In one embodiment, security module 220 also determines a transport protocol for transmitting contact information to the selected partner.

Next, as illustrated at block 330, handset 201 encrypts a portion of the contact database as a contact supplement. For example, encryption module 222 encrypts a portion of contact database 214. In one embodiment, handset 201 encrypts only those contact database records that have changed since the last synchronization with the selected partner. In an alternate embodiment, handset 201 encrypts the entire contact database 214. Generally, a “contact supplement” is contact update information comprising all or a portion of a contact database.

Next, as illustrated at block 335, handset 201 transmits the encrypted contact database to the selected partner. Next, as illustrated at block 340, handset 201 receives an encrypted contact supplement from the selected partner. In one embodiment, the encrypted contact supplement comprises the entire contact database of the selected partner. In an alternate embodiment, handset 201 requests specific contact information and the encrypted contact supplement comprises the requested contact information as stored by the selected partner.

Next, as illustrated at block 345, handset 201 decrypts the received contact supplement. For example, encryption module 222 decrypts the received contact supplement. In one embodiment, format converter 216 also detects the format of the contact supplement and converts the contact supplement into the same format as the contact information stored in contact database 214.

Next, as illustrated at block 350, handset 201 synchronizes the contact database with the received contact supplement. For example, in one embodiment, handset 201 compares the contact information in the received contact supplement with the contact information in contact database 214, and synchronizes the two based on a predetermined synchronization protocol identified in C&C module 206.

Next, as illustrated at block 355, handset 201 terminates the connection and the process ends. Thus, generally, handset 201 initiates and receives fax/modem calls between handset 201 and approved content exchange partners, transferring encrypted portions of a contact database and synchronizing the local contact database with received contact information from a remote partner.

In one embodiment, handset 201 employs a protocol similar to a phone modem or fax machine, exchanged contact list data between the handset and the remote partner. Because the data is somewhat sensitive and transmitted via a telephone call, in one embodiment, the sending handset encrypts the contact supplement for transmission. Additionally, in one embodiment, the exchanged data is standardized, so that any two handsets can exchange data, if the handsets are approved contact exchange partners.

Accordingly, the disclosed embodiments provide numerous advantages over other methods and systems. For example, existing methods for synchronizing telephone contact lists require a hard wiring connection, such as a USB connection, or a close wireless connection, such as an infrared or Bluetooth connection. The embodiments disclosed herein do not require such close physical proximity.

Additionally, the embodiments disclosed herein can be configured to use standard modem protocols common within the telephone industry and therefore do not require additional unrelated hardware such as USB ports, infrared sensors, or Bluetooth sensors. Neither do the embodiments disclosed herein require the handsets' data to maintain identical amounts or types of contact information. For example, the disclosed embodiments can be configured to synchronize a handset that maintains birthday information with a handset that does not maintain birthday information.

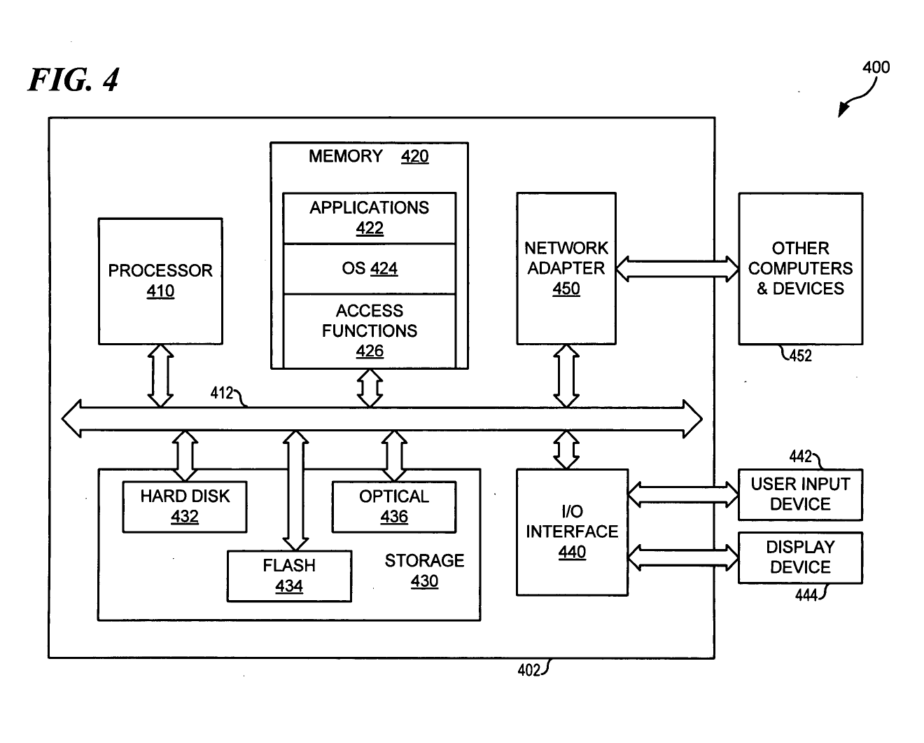

FIG. 4 is a block diagram providing details illustrating an exemplary computer system employable to practice one or more of the embodiments described herein. Specifically, FIG. 4 illustrates a computer system 400. Computer system 400 includes computer 402. Computer 402 is an otherwise conventional computer and includes at least one processor 410. Processor 410 is an otherwise conventional computer processor and can comprise a single-core, dual-core, central processing unit (PU), synergistic PU, attached PU, or other suitable processors.

Processor 410 couples to system bus 412. Bus 412 is an otherwise conventional system bus. As illustrated, the various components of computer 402 couple to bus 412. For example, computer 402 also includes memory 420, which couples to processor 410 through bus 412. Memory 420 is an otherwise conventional computer main memory, and can comprise, for example, random access memory (RAM). Generally, memory 420 stores applications 422, an operating system 424, and access functions 426.

Generally, applications 422 are otherwise conventional software program applications, and can comprise any number of typical programs, as well as computer programs incorporating one or more embodiments. Operating system 424 is an otherwise conventional operating system, and can include, for example, Unix, AIX, Linux, Microsoft Windows™, MacOS™, and other suitable operating systems. Access functions 426 are otherwise conventional access functions, including networking functions, and can be include in operating system 424.

Computer 402 also includes storage 430. Generally, storage 430 is an otherwise conventional device and/or devices for storing data. As illustrated, storage 430 can comprise a hard disk 432, flash or other volatile memory 434, and/or optical storage devices 436. One skilled in the art will understand that other storage media can also be employed.

An I/O interface 440 also couples to bus 412. I/O interface 440 is an otherwise conventional interface. As illustrated, I/O interface 440 couples to devices external to computer 402. In particular, I/O interface 440 couples to user input device 442 and display device 444. Input device 442 is an otherwise conventional input device and can include, for example, mice, keyboards, numeric keypads, touch sensitive screens, microphones, webcams, and other suitable input devices. Display device 444 is an otherwise conventional display device and can include, for example, monitors, LCD displays, GUI screens, text screens, touch sensitive screens, Braille displays, and other suitable display devices.

A network adapter 450 also couples to bus 412. Network adapter 450 is an otherwise conventional network adapter, and can comprise, for example, a wireless, Ethernet, LAN, WAN, or other suitable adapter. As illustrated, network adapter 450 can couple computer 402 to other computers and devices 452. Other computers and devices 452 are otherwise conventional computers and devices typically employed in a networking environment. One skilled in the art will understand that there are many other networking configurations suitable for computer 402 and computer system 400.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

One skilled in the art will appreciate that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A method, comprising:
selecting, by a first telephone handset, a second telephone handset as an approved contact exchange partner;
wherein the first telephone handset and the second telephone handset comprise contact information organized in a database;
establishing a telephone call between the first telephone handset and the second telephone handset;
receiving, by the first telephone handset, contact update information from the second telephone handset in a first protocol; and
synchronizing, by the first telephone handset, the contact update information with the contact information of the first telephone handset.

2. The method of claim 1, further comprising verifying the identity of the second telephone handset.

3. The method of claim 2, wherein verifying the identity of the second telephone handset comprises accessing a list of approved contact exchange partners.

4. The method of claim 1, further comprising encrypting the contact update information.

5. The method of claim 1, further comprising performing a security handshake.

6. The method of claim 1, further comprising:
wherein the contact information of the first telephone handset is in a first format;
wherein the contact information of the second telephone handset is in a second format; and
wherein the first protocol converts the first format to a third format, and the third format to the second format.

7. The method of claim 1, further comprising
receiving, by the second telephone handset, contact update information from the first telephone handset in the first protocol; and
synchronizing, by the second telephone handset, the contact update information with the contact information of the second telephone handset.

8. A computer program product for telephone contact information synchronization, the computer program product stored on a computer usable medium having computer usable program code embodied therewith, the computer useable program code comprising:
computer usable program code configured to select, by a first telephone handset, a second telephone handset as an approved contact exchange partner;
wherein the first telephone handset and the second telephone handset comprise contact information organized in a database;
computer usable program code configured to establish a telephone call between the first telephone handset and the second telephone handset;
computer usable program code configured to receive, by the first telephone handset, contact update information from the second telephone handset in a first protocol; and
computer usable program code configured to synchronize, by the first telephone handset, the contact update information with the contact information of the first telephone handset.

9. The computer program product claim 8, further comprising computer usable program code configured to verify the identity of the second telephone handset.

10. The computer program product of claim 9, wherein verifying the identity of the second telephone handset comprises accessing a list of approved contact exchange partners.

11. The computer program product of claim 8, further comprising computer usable program code configured to encrypt the contact update information.

12. The computer program product of claim 8, further comprising computer usable program code configured to perform a security handshake.

13. The computer program product of claim 8, further comprising:
wherein the contact information of the first telephone handset is in a first format;
wherein the contact information of the second telephone handset is in a second format; and
wherein the first protocol converts the first format to a third format, and the third format to the second format.

14. The computer program product of claim 8, further comprising
computer usable program code configured to receive, by the second telephone handset, contact update information from the first telephone handset in the first protocol; and
computer usable program code configured to synchronize, by the second telephone handset, the contact update information with the contact information of the second telephone handset.

15. A system, comprising:
a first telephone handset comprising a first telephone interface, a first contact database, and a first modem interface;
the telephone interface configured to establish a telephone call between the first telephone handset and a second telephone handset;
the second telephone handset comprising a second telephone interface, a second contact database, and a second modem interface;
wherein the first telephone handset designates the second telephone handset as an approved contact exchange partner;
wherein the second telephone handset is further configured to transmit contact update information based on the second contact database, to the first telephone handset, in a first protocol; and
wherein the first telephone handset is further configured to synchronize the contact update information with the first contact database.

16. The system of claim 15, wherein the first telephone handset is further configured to verify the identity of the second telephone handset.

17. The system of claim 15, wherein the contact update information is encrypted.

18. The system of claim 15, wherein the first telephone handset is further configured to perform a security handshake with the second telephone handset.

19. The system of claim 15, further comprising:
wherein the first contact database is configured in a first format;
wherein the second contact database is configured in a second format; and
wherein the first protocol converts the second format to a third format, and the third format to the first format.

20. The system of claim 15, wherein the second telephone handset is further configured to:
receive contact update information from the first telephone handset in the first protocol; and
synchronize the contact update information with the second database.
